(19) United States
(12) Patent Application Publication
(10) Pub. No.: US 2009/0066032 A1
(43) Pub. Date: Mar. 12, 2009

(54) SLIDING RING SEAL

(76) Inventor: Hans-Henning Zutz, Wermelskirchen (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/293,026

(22) PCT Filed: Jan. 18, 2007
(86) PCT No.: PCT/DE2007/000074

§ 371 Date: Sep. 15, 2008

(30) Foreign Application Priority Data
Mar. 14, 2006 (DE) 10 2006 011 620.8

(51) Int. Cl. F16J 15/38

(52) U.S. Cl. 277/352

(57) ABSTRACT

Device for sealing components which rotate at relatively high speeds, in particular construction machine axles, comprising a sliding ring seal which is formed from a sliding ring and a mating ring, in particular a running gear seal, wherein the sliding and mating rings have a sliding face which faces a rotating component, one of the rings is provided in the installed state on one side within a ring receptacle and on the other side in the region of the rotating component in a manner which is fixed in terms of rotation, and the other ring is arranged in a sealed form with respect to a surrounding stationary component.

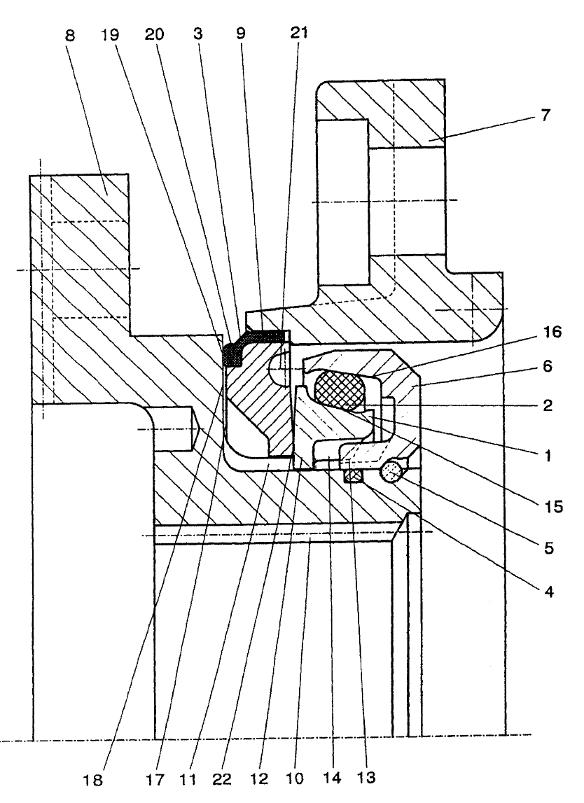

### SPECIFICATION

The invention relates to a device for sealing components rotating at higher rotational speeds, in particular construction machinery axles, comprising a slide ring seal formed of a slide ring and a counter-ring, in particular a running gear seal.

In particular pinion shafts at the differential input, primarily of construction machinery axles, are currently sealed with radial shaft seal rings plus diverse splashguards. Although the dirt acting on this particular seal point would require a wear-resistant slide ring seal, it has hitherto not been possible to use a sealing element of this type because the high rotational speeds exceed the specific power potentials of the available slide ring seals, in particular formed by running gear seals. Furthermore, due to the given high centrifugal forces, albeit small, yet measurable, quantities of oil are spun radially outwards out of the sealing slot, thus becoming visible as leakage.

DE-B3 10 2004 036 974 discloses a slide ring seal, in particular a running gear seal, comprising a counter-ring and a slide ring each with a bearing area for accommodating an elastic element, a housing assigned to the counter-ring and slide ring with a counter-clamping surface for the elastic element, the housings lying one inside the other being connected to form a mounting unit and an anti-rotation lock being provided in the region of the counter-ring and the slide ring.

DE-A 103 52 675 describes a slide ring seal, in particular a running gear seal, comprising a metallic slide ring and/or counter-ring that is provided with an anti-abrasion layer in the area of its working surface.

The object of the invention is to further develop a slide ring seal, in particular a running gear seal, such that it can also be effectively used for special applications that entail higher circumferential speeds.

This object is attained through a device for sealing components rotating at higher speeds, in particular construction machinery axles, comprising a slide ring seal, in particular a running gear seal, formed of a slide ring and counter-ring, the slide ring and counter-ring having a slide surface facing toward a rotating component, one of the rings in the assembled state being provided in a rotationally locked manner on the one hand inside a ring receiving element and on the other hand in the region of the rotating component, and the other ring being arranged in a sealed form with respect to an enclosing stationary component.

Advantageous further developments of the subject matter of the invention can be taken from the subordinate claims.

The concrete embodiment of the slide ring seal, in particular running gear seal, according to the invention thus provides the possibility of being used as an alternative sealing element to a radial shaft seal ring susceptible to wear. In particular construction machines are vehicles that in the operating state have constantly changing driving conditions (forward and backward operation) so that the referenced anti-rotation locks according to the invention on the one hand between the rotating ring and the associated ring receiving element and on the other hand between the rotating ring and the rotating component can develop an optimal effect.

The slide ring seal is embodied such that the oil feed of the sealing slot is not carried out from the interior diameter as is customary, but instead from the external diameter. This measure effectively ensures that no leakage can occur radially from the inside outwards. The centrifugal forces acting on the oil film thus act against the leakage direction, which means that the lubricant can no longer be spun out.

Since with the sealing concept according to the invention the dirt to be sealed out can reach the sealing surface from the interior diameter, it must be ensured that the area loaded with dirt is not completely clogged, which could jeopardize the function of the slide ring seal. In order to counteract this, the rotating component or the stationary ring or both components are provided on the front face with a conveyor element (e.g., a conveyor screw thread) acting radially outwards.

Depending on the tolerance selected, the region of the anti-rotation lock can be embodied like guillotine shears so that dirt entering is constantly broken up and thus can be more easily conveyed outwards again.

According to another concept of the invention, the slide ring seal can be designed as an assembly. This means that the rotating component is provided with the seal unit before assembly, e.g., on a pinion shaft. The stationary ring is hereby pushed onto the rotating component. Through the peripheral web on the interior diameter of the rotating component, the necessary centering is carried out for the subsequent assembly into a surrounding, stationary component embodied, e.g., as a casing cover. A peripheral sealing bead, preferably of wear-resistant elastomer material, is located on the rear of the stationary ring. This bead has the function on the one hand of axially supporting the stationary ring in pushing the entire assembly onto the rotating component embodied as a pinion shaft so that it can be pressed into the casing. On the other hand, after a short period of use of the slide ring seal this bead is subjected to a specific wear, so that the stationary ring no longer has any contact with the rotating component. The stationary ring is provided with at least one lubricant collection groove in the region of its front face lying opposite the rotating ring and provided outside the slide surface.

If for the respective use of the slide ring seal according to the invention the subject of wear of the slide surface is to be taken into consideration, for example, the prior art pursuant to DE 103 52 675 can be fallen back on or other solution methods can be considered for increasing the wear resistance of the slide surface.

The subject matter of the invention is shown in the drawing based on an exemplary embodiment and is described as follows.

The only FIGURE shows as a schematic diagram a cross section through the slide ring seal according to the invention embodied as a running gear seal. The following components are shown:

A rotating slide ring 1, an elastic element embodied as an O-ring 2, a stationary counter-ring 3, a static seal element 4, a round wire snap ring 5 as a securing element, a ring receiving element 6, a stationary component 7 embodied as a casing cover, as well as a rotating component 8 embodied in this example as a drive flange. Finally, a static sealing element 9 is provided, which is supported between the counter-ring 3 and the component 7.

The rotating component 8 is provided in the region of its interior diameter with a toothed region 10, which in the assembled state is brought into active engagement with a pinion shaft, not shown in further detail.

The rotating component 8 is provided with slots/webs 11 of predetermined length in which correspondingly embodied radial webs 12 of the slide ring 1 engage in the assembled state, such that a first anti-rotation lock is formed between the slide ring 1 and the rotating component 8. The ring receiving element 6 is provided with axially aligned projections 13 that engage in corresponding grooves 14 provided on the slide ring side. A second anti-rotation lock is thus formed between the slide ring 1 and the ring receiving element 6. The elastic element 2 extends between areas 15, 16 running conically on one side of the slide ring 1 and on the other side of the ring receiving element 6. The region of the respective anti-rotation lock 11, 12, or respectively 13, 14, can also be formed by elements mounted by vulcanization so that the noise behavior remains low with changing directions of rotation and unfavorable tolerances. Dirt that may have penetrated from outside can be crushed here so that a transport outwards is more easily carried out. In order to ensure this, in this example the front face 17, facing towards the stationary counter-ring 3, of the rotating component 8 is embodied in the form of a conveyor screw thread. The counter-ring 3 is provided in the region of its front face 18 facing towards the front face 17 with a step 19 that accommodates a sealing bead 20 formed on the sealing element 9.

The slide ring seal embodied as a running gear seal is designed as an assembly. That means that the rotating component 8 is equipped as follows before mounting on the pinion shaft, not shown in further detail:

The stationary counter-ring 3 is pushed onto the rotating component 8. The peripheral bead 20, preferably of wear-resistant elastomer material, is located on the rear of the counter-ring 3. This bead 20 has on the one hand the function of axially supporting the counter-ring 3 during pushing the entire assembly onto the pinion shaft, so that it can be pressed into the stationary component 7. On the other hand, after a short time in operation of the unit, this bead 20 is subjected to a specific wear. After corresponding wear of the bead 20, a slight gap remains between the front faces 17 and 18 so that the referenced conveyor device can become effective for dirt particles that have penetrated. The package, comprising slide ring 1 and elastic element 2, is pushed onto the ring receiving element 6 preassembled and an anti-rotation lock 13, 14 is thus generated. Subsequently the pushing on of the component 8 and the anti-rotation lock 11, 12 is effected. The assembly 6, 1, 2 is then axially displaced so far that the round wire snap ring 5 snaps into its groove. The static seal is produced via a commercially available round section seal 4. After preassembly of the rotating component 8 on the pinion shaft (not shown) has been carried out, a connection with the stationary component 7 can be effected by pressing in the preassembled unit. The oil feed of the sealing slot between the slide ring 1 and counter-ring 3 is carried out radially from the outside, the counter-ring 3 being provided with a lubricant collection groove 21 on the slide ring side. In order that the wear of the slide surfaces 22 remains low even at higher speeds, at least the slide surfaces 22 are provided in a wear-resistant embodiment. Thermally conductive materials with possibly additional laser hardening lend themselves here. One skilled in the art will select suitable materials and their processing depending on the use.

1. Device for sealing a rotating component relative to a surrounding stationary component, comprising a slide ring seal formed of a slide ring and a counter-ring, the slide ring and counter-ring having a slide surface facing toward a rotating component, one of the slide and counter rings in the assembled state being provided in a rotationally locked manner inside a ring receiving element and in the region of the rotating component, and the other of the rings being arranged in a sealed form with respect to the surrounding stationary component.

2. Device according to claim 1, wherein an elastic element is provided between the ring receiving element and the associated one ring, which elastic element is supported on areas running approximately conically on the ring receiving element and on the one ring.

3. Device according to claim 1, wherein the ring receiving element is formed by a body that is approximately U-shaped in cross section, which is fixed with respect to the rotating component by means of a securing element.

4. Device according to claim 1, wherein the rotationally locked manner of the one ring and the ring receiving element is formed by corresponding projections and grooves lying one inside the other.

5. Device according to claim 4, wherein the projections point in the direction of the one ring, which projections are guided in corresponding grooves on the ring side.

6. Device according to claim 1, wherein the rotationally locked manner of the one ring and the rotating component is formed by corresponding interlocking webs and slots.

7. Device according to claim 6, wherein the webs run radially on the one ring, which webs are guided in the slots of the rotating component.

8. Device according to claim 7, wherein elastically acting material is provided in the region of the projections/grooves and the webs/slots respectively.

9. Device according to claim 8, wherein the projections/grooves and webs/slots respectively are formed by elastically acting elements mounted by means of vulcanization.

10. Device according to claim 1, wherein the ring receiving element is provided with defined radial clearance to the surrounding stationary component.

11. Device according to claim 1, wherein the other ring is stationary and has an offset region outside its slide surface, in which offset region a sealing bead interacting with a sealing element is provided.

12. Device according to claim 1, wherein the rotating component and/or an opposite front face of the other ring is provided with a conveyor means acting radially outwards for dirt particles that have penetrated.

13. Device according to claim 12, wherein the other ring has a peripheral collection recess for lubricant radially outside its slide surface and facing towards the rotating one ring.

14. Device according to claim 1, wherein the stationary one ring, the rotating other ring, the sealing element and the ring receiving element can be attached to the rotating component and can be fixed in their position by the securing element, and that the unit thus preassembled, including the sealing bead together with the sealing element, can be pressed into the stationary component forming an axial stop.

15. Device according to claim 1, wherein the slide surface between of the one ring and of the other ring wear-resistant.

16. Device according to claim 4, wherein elastically acting material is provided in the region of the grooves and the slots respectively.

17. Device according to claim 16, wherein the grooves and slots respectively are formed by elastically acting elements mounted by means of vulcanization.
